(19) United States
(12) Patent Application Publication
(10) Pub. No.: US 2006/0077777 A1
(43) Pub. Date: Apr. 13, 2006

(54) Water and shock resistant music player

(76) Inventor: Lance Fried, Del Mar, CA (US)

Correspondence Address: STETINA BRUNDA GARRED & BRUCKER, 75 ENTERPRISE, SUITE 250, ALISO VIEJO, CA, 92656, US

(21) Appl. No.: 11/222,163

(22) Filed: Sep. 8, 2005

Related U.S. Application Data
(60) Provisional application No. 60/608,856, filed on Sep. 10, 2004.

(51) Int. Cl. G11B 21/08

(52) U.S. Cl. 369/30.85

(57) ABSTRACT

A water proof and shock resistant music player is provided which permits a user to listen to his/her favorite music while engaged in his/her favorite sport. For example, the user may listen to music while surfing or boogie boarding. The music player comprises an upper housing and a lower housing. The housings have button apertures with rim grooves formed about an inner periphery of the button apertures. Buttons are sized and configured to fit within the button apertures, and rim portions of the buttons are sized and configured to have a snug fit with the rim grooves such that there is a water tight seal therebetween and the user of the music player may engage in water related activities. The buttons are traverseable between a depressed position which activates switches to control the music player and a retracted position to deactivate the switches. In particular, the buttons may have a flexible member and a rigid member inserted inside of the flexible member. The flexible member provides the water tight seal with the housings and the rigid member activates the switches.

### CROSS-REFERENCE TO RELATED APPLICATIONS

This application claims benefits of U.S. Provisional Application No. 60/608,856, filed Sep. 10, 2004, the entire contents of which are incorporated herein by reference.

### STATEMENT RE: FEDERALLY SPONSORED RESEARCH/DEVELOPMENT

Not Applicable

### BACKGROUND

The present invention relates generally to a music player, and more particularly to a water proof and shock resistant MP3 player wherein a user may listen to music while the user is engaged in a water related sport and/or vigorous activity.

Active people, hikers, surfers, snowboarders and the like, enjoy listening to music while engaging in vigorous physical activities which may include the risk or inevitability of getting wet. One method for the participant to listen to his/her favorite music while engaged in the vigorous physical activity is to listen to a compact disc. However, a CD player has many inherent problems such as weight, track skipping, and size. Additionally, for snowboarding and swimming, participants cannot listen to music with CD players because CD players are not water resistant. Moreover, CD players are typically too large and too heavy for the active person to carry the CD player while engaging in the vigorous physical activity.

Accordingly, there is a need in the art for an improved music playing device wherein a user may listen to music while participating in vigorous physical activity including water related sports.

### BRIEF SUMMARY

The various aspects of a music player described herein addresses the needs discussed in the summary and those needs identified herein as well as those that are known in the art. In particular, the music player is a shock resistant music player such that a user may wear the music player via an arm band while the user is participating in vigorous physical activity such as surfing. Even though the waves may tumble the participant, the music player continuously plays music for the user's listening enjoyment. The music player is also water resistant such that electronic components (e.g., IC chip, battery, and the like) contained within a housing of the music player does not get wet thereby damaging the electronic components.

The music player is water resistant due to a combination of grooves formed in the upper and lower housings which are sized and configured to receive a rim portion of a button and a ring disposed about a plug. The buttons control the operation of the music player such as fast forward, on/off, etc. The plug is an input/output device such that a jack of a waterproof earphone may be inserted into the plug such that the user may listen to the music being played on the music player. The plug is also communicable with a USB cable such that a user may connect the music player to a computer for downloading and uploading music onto the music player.

The grooves/rim portion/ring combination may have the following structure. The upper and lower housings may be formed to collectively define button apertures and a plug aperture. The upper housing may have a plurality of semi circularly shaped depressions which mate to semi circularly shaped depressions of the lower housing to collectively define the button apertures and the plug apertures. The button apertures and the plug apertures may respectively have rim grooves and a ring groove for receiving the rim portion of the button and the ring disposed about the plug. The rim portions and ring may be received into the rim grooves and the ring groove, respectively. When the upper and lower housings are engaged to each other, the rim grooves compress onto the rim portion to form a water tight seal therebetween. Also, the ring grooves compress onto the ring disposed around the plug to form a water tight seal therebetween. Moreover, the interface surfaces of the upper and lower housings may be engaged (e.g., sonically welded, etc.) to each other to form a water tight seal at the interface surfaces. Hence, by the above construction, electronic components disposed within a cavity formed by the upper and lower housings is protected from water when the music player is submersed under water.

The buttons are traversable through the button apertures between a depressed position and a normal position. When the buttons are depressed, switches connected to the PCB board are activated thereby controlling the operations of the music player. The buttons are traversable through the button apertures and a water tight seal is maintained due to a flexible member/rigid member combination. In particular, the rigid member depresses the switch and the rim portion of the flexible member remains snugly fitted into the rim grooves for a water tight seal. More particularly, the rigid member may be inserted into a hole formed in the flexible member and extend out of the rim portion of the flexible member. The portion of the rigid member extending out of the rim portion referred to as a second distal end of the rigid member may be aligned to switches which operate the function of the music player. The hole formed in the flexible member is not formed all the way through the flexible member such that water does not enter the housing through such hole. The buttons are received into button apertures collectively formed by the upper and lower housings. The flexible member permits the rigid member to sufficiently slide within the flexible member such that the second distal end of the rigid member may contact and depress the switch to control the music player's operation when the button is traversed to the depressed position. Also, rim portions of the buttons remain snugly fitted into rim grooves of the upper and lower housings to provide a water tight seal while the rigid member slides within the flexible member.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an illustration of a swimmer listening to music with a water resistant and shock resistant music player wherein the music player is engaged to the participant's arm via an arm band;

FIG. 2 is a perspective view of the music player removed from the arm band and an earphone removed from an earphone plug of the music player;

FIG. 3 is an exploded perspective view of the music player illustrating four buttons and the earphone plug wherein rim portions of buttons and a ring disposable about the plug are respectively received into rim grooves and a ring groove to make the music player water resistant;

FIG. 4 is a top view of the upper housing with alignment pins of the upper housing engaged to alignment holes of the PCB board and the ring disposed about the plug received into the ring groove of the upper housing;

FIG. 5 is a cross sectional top view of the button in the button aperture illustrating a rim portion of a flexible member disposed within the rim groove for forming a water tight seal therebetween; and

FIG. 6 is a cross sectional front elevational view of the button in the button aperture illustrating a band disposed in recesses of the upper and lower housing periphery.

### DETAILED DESCRIPTION

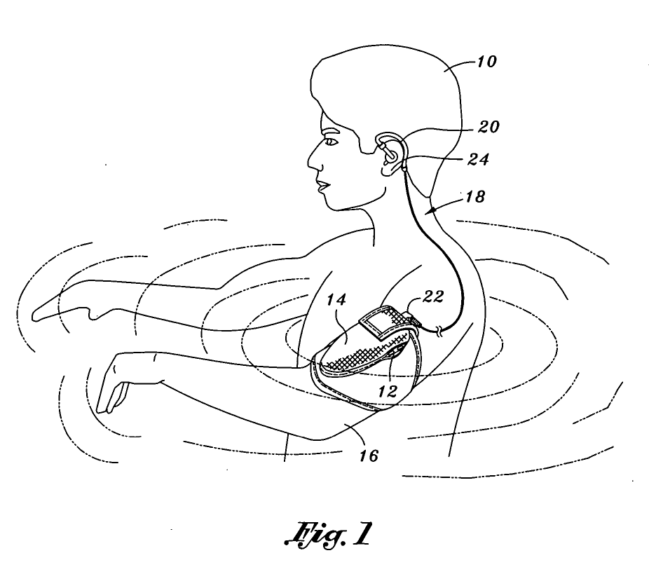

Referring now to the drawings which are for the purposes of illustrating the preferred embodiments of the present invention and not for the purposes of limiting the same, FIG. 1 illustrates a user 10 listening to a music player 12 while swimming. The music player 12 is inserted into an armband 14 wrapped and secured to a left arm 16 of the person 10. An ear phone 18 is also shown having an ear bud 20 and a jack 22. The jack 22 is connected to the music player 12 and the ear bud 20 is inserted into an ear 24 of the user 10. The music player 12 permits the user 10 to simultaneously swim and listen to music.

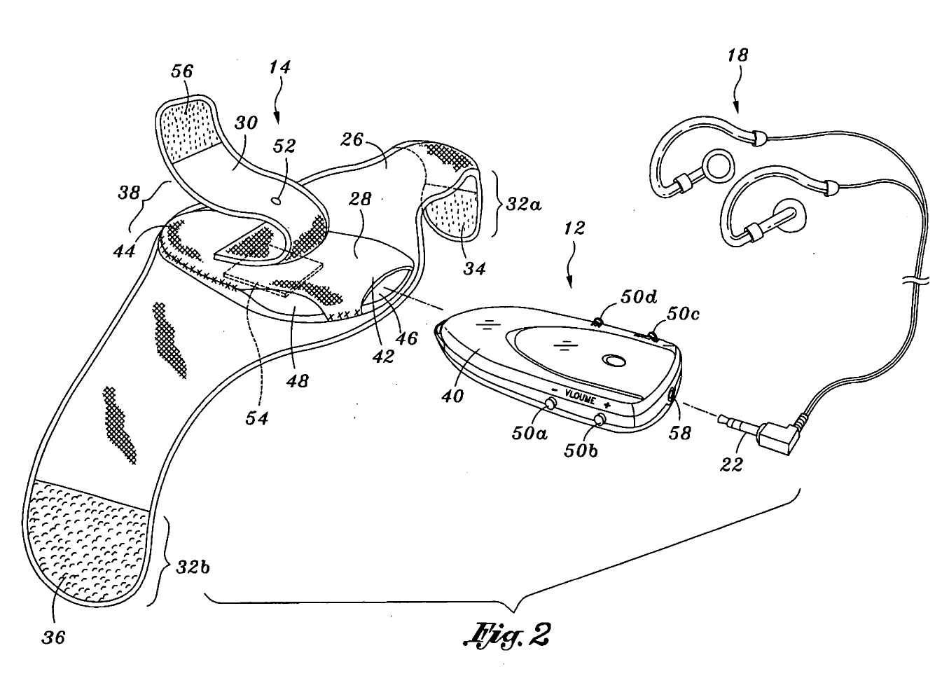

FIG. 2 illustrates the armband 14, the music player 12 and the earphone 18. The armband 14 may comprise a strap 26, pouch 28 and a closing flap 30. The strap 26 may be fabricated from a neoprene material and sized and configured to fit around the user's arm 16. The distal ends 32a, b of the strap 26 may have hooks 34 and loops 36 respectively attached to ends 32a, b. The strap 26 may be wrapped around the user's arm 16, and the hooks 34 and loops 36 may engage each other to attach the armband 14 to the user's arm 16.

The pouch 28 may be attached to a central portion 38 of the strap 26 on its outside surface. The pouch 28 may also be fabricated from a neoprene material sized and configured to the general shape of a casing 40 of the music player 12. In particular, the pouch 28 may be fabricated to have a rounded top portion 42 and tapered bottom portion 44. The pouch 28 may further define an entrance/exit or opening 46 through which the music player 12 may be inserted into or removed from the pouch 28. The opening 46 may be smaller than the music player 12 such that the opening 46 must be stretched open to insert the music player 12 into the pouch 28 or to remove the music player 12 from the pouch 28. This provides additional capture of the music player 12 inside the pouch 28 in addition to the closing flap 30. The pouch 28 may further have button openings 48 on the left and right hand sides of the pouch 28 sized, configured and positioned to allow the user 10 to feel and depress buttons 50a-d of the music player 12. The closing flap 30 may be attached to an outside surface of the pouch 28 and removably attachable to an inside surface of the strap 26. The closing flap may a jack aperture 52 sized and configured to receive the jack 22 of the earphone 18, as shown in FIGS. 1 and 2. The inside surface of the strap 26 and the inside surface of the closing flap 30 may be respectively lined with hooks 54 and loops 56 such that the closing flap 30 may cover the opening 46 when the closing flap 30 is in a closed position (see FIG. 1) and the hooks 54 and loops 56 lined on the inside surfaces of the strap 26 and closing flap 30 may be engaged to each other. In the closed position, the jack aperture 52 may be aligned to a plug 58 of the music player 12 such that the jack 22 of the earphone 18 may be plugged into the plug 58 when the flap 30 is in the closed position. To remove the music player 12 from the pouch 28, the user 10 may remove the jack 22 from the plug 58. The loops 56 may be disengaged from the hooks 54, and the music player 12 may be slipped out of the pouch 28 through opening 46.

The discussion of the operation of the music player 12 itself is exemplary and not meant to limit the present invention. It is also contemplated that other operation schemes may be employed in conjunction with the various aspects of the music player 12 discussed herein. The music player 12 may be turned on by pressing the on/off button 50c for three seconds while the jack 22 of the earphone 18 (i.e., output devices) is attached to the plug 58. The music player 12 may be turned off by disengaging the jack 22 from the plug 58. Alternatively, and more preferably, the music player 12 may be turned off by depressing the on/off button 50c for three seconds. While the music player 12 is on, a subsequent song or previous song may be played by depressing either the next track button 50c or the previous track button 50d, respectively. To replay the current song, the previous track button 50d may be depressed. To adjust the volume, the increase or decrease volume buttons 50a, b may be depressed. These buttons 50a-d activate the switches 60a-d (see FIG. 3) formed on a PCB 62 to control the music player 12.

The music player 12 may be manufactured to be water resistant such that the user 10 may engage in water sports while listening to his or her favorite music. Additionally, the music player 12 may be shock resistant such that the user 10 may engage in vigorous physical activity without interruption of the music being played. To this end, as shown in FIG. 3, the music player 12 may have a plurality of electronic components 64 formed on the printed circuit board (PCB) 62. The PCB 62 and the electronic components 64 may cooperate with each other to play music. The electronic components 64 may include a battery which may be rechargeable and a flash memory (by way of example and not limitation, 128 megabyte, 256 megabyte and 1 gigabyte). The electronic components 64 may include software embedded on an IC chip to play music downloaded onto the flash memory. The software may play MP3 formatted music as well as all common music formats.

The plug 58 may also be attached to the PCB 62 at a distal end thereof. The plug 58 may be a 3.5 mm plug and may also be waterproof. The plug 58 may be connected to output devices such as amplified speakers, headphones, earphones 18, and the like. The plug 58 may also be connected to a USB cable adaptor. The USB cable adaptor may have a cable jack and USB connector with a cable connecting the cable jack and the USB connector. The cable jack may be inserted into the plug 58 and the USB connector may be connected to a USB port of a computer to permit downloading of music files from the computer to the music player 12, and more particularly, to the flash memory of the music player 12. Additionally, the USB cable adaptor may provide power to the music player 12 for recharging the battery of the music player 12.

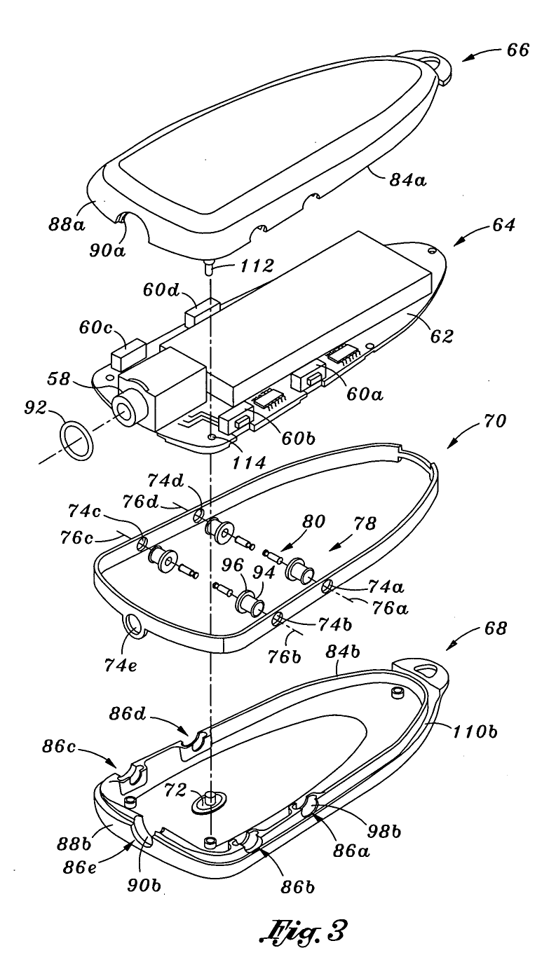

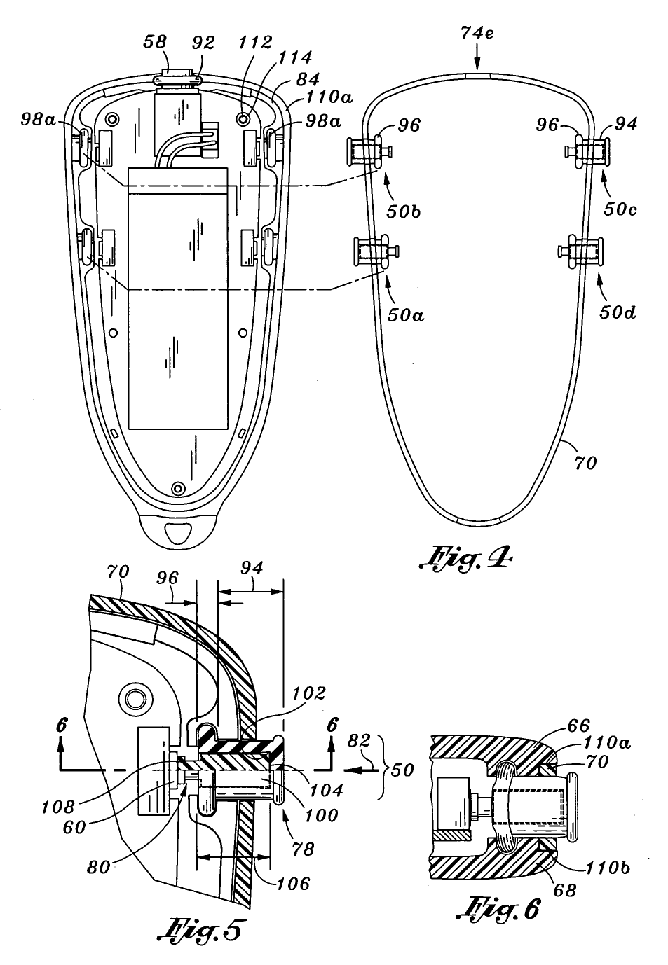

The music player 12 may have an upper housing 66, a lower housing 68 and a band 70 disposed therebetween which when assembled together forms a cavity to contain the electronic components 64 and resists water from entering into the cavity. The lower housing 68 may have a transparent window 72 such that a light emitting diode (LED) may emit light through the transparent window 72. The LED may be one of the electronic components 64 attached to the PCB 62. The LED functions to indicate a status of the MP3 player 12 such as whether a song is being played or whether the battery of the music player 12 is being charged. The band 70, upper housing 66 and lower housing 68 may contact each other to form a water tight seal therebetween. For example, the upper housing 66, lower housing 68 and the band 70 disposed therebetween may be sonically welded to each other. The band 70 may have a plurality of apertures 74a-d for receiving the buttons 50a-d (see FIG. 4) and the plug 58. In particular, an upper portion of the band 70 may have a plug aperture 74e sized and configured to receive the plug 58 therethrough. Left and right portions of the band 70 may have two button apertures 74a, b and 74 c, d on each portion. The button apertures 74a-d may be sized and configured to receive buttons 50a-d, respectively. The buttons 50a-d may be operative to control switches 60a-d, respectively, attached to the PCB board 62. A center line 76a-d of the button apertures 74a-d, respectively, may be aligned to the switches 60a-d attached to the PCB board 62 when the MP3 player 12 is assembled. The buttons 50a-d may have flexible members 78 which permit minute movements of rigid members 80 through the apertures 74a-d. The rigid member 80 may be disposed through a core of the button 50a-d. As shown in FIG. 5, the rigid member 80 may be aligned to the switch 60 and in contact therewith and extend into the distal tip of the button 50. Depressing the flexible member 78 in the direction of arrow 82 by the user's fingers is operative to traverse the rigid member 80 against the switch 60 and depress the switch 60 to control the operation of the music player 12, as shown in FIG. 6.

The upper and lower housings 66, 68 may have a cup-shaped configuration. A periphery of each of the upper and lower housings 66, 68 may define an interface surface 84a, b (see FIGS. 3 and 4). The upper housing 66 may be disposed above the lower housing 68 with the interface surface 84a of the upper housing 66 in alignment with the interface surface 84b of the lower housing 68. When the interface surfaces 84a, b of the upper housing 66 and the lower housing 68 are in contact with each other, a cavity is formed therebetween which houses the electronic components 64. When the interface surfaces 84a, b of the upper and lower housings 66, 68 are sonically welded, a watertight seal is formed therebetween. However, the upper and lower housings 66, 68 form button apertures 86a-e for the buttons 50a-d and the plug 58. As such, water may still enter the cavity through button and plug apertures 86a-e but is prevented as discussed below.

The button and plug apertures 86a-e permit the user 10 of the music player 12 to insert a jack 22 of an earphone 18 into a plug 58 attached to the PCB board 62 and to depress buttons 50a-d to control the switches 60a-d. More particularly, the plug 58 may be attached to the PCB board 62 and extend through sidewall portions 88a, b (see FIG. 3) of the upper and lower housings 66, 68. The plug 58 may have a generally circular configuration. The plug aperture 86e may be sized to be slightly larger than a diameter of the plug 58 such that the plug 58 may be inserted therethrough. The plug aperture 86e may be defined by a semi-circularly shaped depression formed in the lower housing 68 which mates with a corresponding semi-circularly shaped depression in the upper housing 66. When the interface surface 84a of the upper housing 66 mates with the interface surface 84b of the lower housing, then plug aperture 68e is formed.

The semi-circularly shaped depressions may have donut shaped grooves 90a, b (see FIG. 3) sized and configured to receive a ring 92 disposable about the plug 58. During assembly, the PCB board 62 with the plug 58 attached thereto may have the ring 92 disposed about the plug 58. The PCB board 62 may be disposed within the upper housing 66 with the plug 58 disposed in the semi-circularly shaped depression of the upper housing 66. Moreover, the ring 92 disposed around the plug 58 may be disposed in groove 90a of the upper housing 66. The interface surface 84a of the upper housing 66 may be aligned and placed in contact with the interface surface 84b of the lower housing 68. Moreover, in this position, the depression formed in the sidewall portion of the lower housing 68 also receives the plug 58, and the groove 90b receives the ring 92 disposed around the plug 58. The interface surfaces 84a, b of the upper and lower housings 66, 68 may be sonically welded to each other to assemble the music player 12. When assembled, the ring 92 being slightly larger than the grooves 90a, b is snugly fitted within the grooves 90a, b of the lower and upper housings 66, 68. The snug fit between the ring 92 and the grooves 90a,b of the housings 66, 68 forms a watertight seal therebetween. In this manner, a jack 22 of the earphone 18 may be plugged into the plug 58 for receiving electronic signals from the music player 12 and delivering such signals to the ear bud 20 of the earphone 18 such that the user 10 may enjoy listening to the music being played while in wet conditions.

The buttons 50a-d which control the operations of the music player 12 may be inserted into button apertures 86a-d so as to form a water tight seal therewith. In particular, the buttons 50a-d may have the flexible member 78 and the rigid member 80, as shown in FIG. 3. The flexible member 78 may have a hat-shaped configuration defined by a nub portion 94 and a rim portion 96. The nub and rim portions 94, 96 may have cylindrical configurations (see FIG. 3) wherein a central axis of the nub portion 94 and a central axis 96 of the rim portion 96 are aligned with each other. The nub portion 94 and the rim portion 96 may be fabricated from a unitary material such as rubber or other elastomeric material. The button apertures 86a-d for receiving the buttons 50a-d may be defined by semi-circularly shaped depressions formed in the upper and lower housings 66, 68. The button apertures 86a-d may be sized and configured to receive the nub and rim portions 94, 96 of the flexible member 78 and the rigid member 80, as shown in FIG. 5. The semi-circularly shaped depressions formed in the upper and lower housings 66, 68 may also have donut shaped grooves 98a, b (see FIGS. 3 and 4). Groove 98a of the upper housing 66 is best shown in FIG. 4, and groove 98b of the lower housing 68 is best shown in FIG. 3. The donut shaped grooves 98a, b of the upper and lower housings 66, 68 may collectively receive the rim portion 96 of the flexible member 78. When the rim portion 96 is received in the grooves 98a, b of the upper and lower housings 66, 68 and the interface surfaces 84a, b of the upper and lower housings 66, 68 are assembled (e.g., sonic welding, etc.), a watertight seal is formed between the interface surfaces 84a, b of the upper and lower housings 66, 68 as well as between the button 50 and the button aperture 86.

The button apertures 86a-d (see FIG. 3) may also define a central axis which is in alignment with the switches 60a-d attached to the PCB board 62, as shown in FIG. 5. Additionally, a hole may be formed through the rim portion 96 and the nub portion 94 of the flexible member 78. The hole may extend through the rim portion 96 and extend to the nub portion 94. However, the hole should not extend through the entire nub portion 94 so as to make a hole through the button 50 such that water does not enter the housing through such hole.

The hole and rigid member 80 may be sized and configured such that the rigid member 80 may snuggly fit within the hole but may also be slidable therethrough. A first distal end 100 of the rigid member 80 may have a bulbous configuration with an edge 102 (see FIG. 5) to prevent the rigid member 80 from being pulled out of the hole. The first distal end 100 of the rigid member 80 may be inserted into the hole until the first distal end 100 contacts a bottom 104 of the hole. The rigid member 80 may be longer than a depth 106 of the hole and a second distal end 108 of the rigid member 80 may be disposed adjacent to a switch 60. When the upper and lower housings 66, 68 are assembled with the buttons 50a-d and PCB board 62, the user 10 may press the button 50 in direction 82 to slide the rigid member 80 through the hole such that the second distal end 108 of the rigid member 80 depresses the switch 60 (see FIG. 6). This controls the operation of the music player 12. When the user's finger releases the button 50, the switch 60 springs outwardly and traverses the rigid member 80 back to its normal position (see FIG. 5).

As shown in FIG. 6, the band 70 may be interposed between the upper and lower housings 66, 68. In particular, the upper and lower housings 66, 68 may be formed with a recess 110a, b about peripheries of the upper and lower housings 66, 68, as shown in FIGS. 3 and 4. More particularly, as shown in FIGS. 4 and 6, the upper housing 66 may be formed with a recess 110a about the periphery thereof. Also, as shown in FIGS. 3 and 6, the lower housing 68 may be formed with a recess 110b about the periphery thereof. The recesses 110a, b may be sized and configured to receive the band 70 therein such that the band 70 is substantially flush with an exterior of the upper and lower housings 66, 68, as shown in FIGS. 2 and 6. The band 70 may also have four button apertures 74a-d (see FIG. 3) which may be sized and configured to receive the nub portion 94 of the buttons 50a-d, as shown in FIG. 4. The band 70 with the buttons 50a-d inserted into the button apertures 74a-d may be placed into the recess 110a of the upper housing periphery with the rim portions 96 of the buttons 50a-d received into the grooves 98a. Additionally, the plug 58 with the ring 92 disposed thereabout may be inserted into aperture 74e. The interface surfaces 84a, b of the upper and lower housings 66, 68 may be aligned and sonically welded to each other, as shown in FIG. 6.

To assemble the music player 12, the ring 92 may be disposed about the plug 58. Alignment pins 112 (see FIG. 3) formed in the upper housing 66 may then be inserted into alignment holes 114 (see FIG. 3) formed in the PCB board 62, as shown in FIG. 4. At this time, the ring 92 is disposed in groove 90a of the upper housing 66. The rigid member 80 may be inserted into the holes of the flexible member 78 to assemble the button 50. The buttons 50a-d may be inserted into the button apertures 74a-d of the band 70, as shown in FIG. 4. Thereafter, the band 70 may be placed on the recess 110a of the upper housing periphery with the nub portions 94 of the buttons 50a-d placed into the semi-circularly shaped depressions of the upper housing 66 and the rim portions 96 placed into the grooves 98a. The interface surface 84b of the lower housing 68 may be aligned and engaged (e.g., sonically welded, etc.) to the interface surface 84a of the upper housing 66. The engagement of the interface surfaces 84a, b of the upper and lower housings 66, 68 creates a water tight seal therebetween. The ring 92 and the rim portions 96 of the buttons 50a-d create a water tight seal with the grooves 90a, b and 98a, b of the upper and lower housings 66, 68. Hence, water does not enter the cavity formed by the upper and lower housings 66, 68 thereby protecting the PCB board 62 from water damage.

Another advantage of the music player 12 is that the music player 12 is resistant to shocks. The user 10 may be engaged in vigorous physical activity such as surfing or cycling. The user 10 may be violently tumbled by the waves or may ride over bumps in the road. Nonetheless, the music player 12 continuously plays music without skipping. Moreover, the solid construction of the music player 12 prevents the shocks from destroying the music player 12.

The above description is given by way of example, and not limitation. Given the above disclosure, one skilled in the art could devise variations that are within the scope and spirit of the invention disclosed herein, including various ways of engaging the interface surfaces 84a, b of the upper and lower housings 66, 68. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A water and shock resistant electronic music player for listening to music while a user is engaged in vigorous physical activity, the player comprising:
a) electronic components collectively operative to play music, the components including:
i) a memory chip operative to store music;
ii) an integrated circuit in communication with the memory chip and operative to play music stored on the memory chip;
iii) an earphone plug electrically connected to the integrated circuit and operative to receive an earphone jack of an earphone for listening to the music being played;
iv) at least one switch in communication with the integrated circuit operative to control operations of the integrated circuit and the memory;
b) an elastomeric seal disposed about a periphery of the earphone plug;
c) a casing encapsulating the electronic components, the casing having a first earphone plug aperture with a seal groove about an inner periphery of the earphone plug aperture, the first earphone plug aperture being sized and configured to receive the earphone plug and the seal groove being sized and configured to receive the elastomeric seal for providing a water resistant casing such that the electronic components remain dry when the music player is submersed in water.

2. The player of claim 1 wherein the casing comprises:
i) an upper housing and a lower housing collectively defining the first earphone plug aperture and the seal groove about the inner periphery of the first earphone plug aperture;
ii) wherein the elastomeric seal is an O-ring.

3. The player of claim 2 wherein each of the upper housing and the lower housing has a semi circularly shaped depression to collectively define the first earphone plug aperture, and wherein each of the upper housing and the lower housing has a donut shaped groove to collectively define the seal groove.

4. The player of claim 2 wherein the first earphone plug aperture is sized and configured to be compressed onto the elastomeric seal.

5. The player of claim 1 wherein the casing includes at least one first button aperture with a rim groove about an inner periphery of the first button aperture, and the player further comprises:
d) at least one button with a rim portion;
e) wherein the first button aperture is sized and configured to receive the button therethrough and the rim groove is sized and configured to receive the rim portion for providing a water resistant casing such that the electronic components remain dry when the music player is submersed in water.

6. The player of claim 5 wherein the button comprises:
i) a flexible member defining a nub portion and the rim portion, the flexible member having a hole extending through the rim and in the nub; and
ii) a rigid member sized and configured to be received into the hole of the flexible member, the rigid member being longer than a depth of the hole such that the rigid member protrudes from the rim of the flexible member, the rigid member is sufficiently traverseable within the button aperture between a depressed position and a retracted position, the rigid member activates the switch when in the depressed position and deactivates the switch when in the retracted position.

7. The player of claim 2 further comprising a band sized and configured to circumscribe an outer periphery of the upper and lower housings at interface surfaces of the upper and lower surfaces, the band having a second earphone plug aperture aligned to the first earphone plug aperture of the casing, the band having a second button aperture aligned to the first button aperture of the casing, wherein the band, upper housing and the lower housing are sonically welded together for providing a shock resistant music player.

8. The player of claim 7 wherein the upper and lower housings have band recesses about its peripheries for collectively receiving the band.

9. The player of claim 7 wherein interface surfaces of the upper housing and the lower housing are sonically welded to each other.

10. A water and shock resistant electronic music player for listening to music while a user is engaged in vigorous physical activity, the player comprising:
a) electronic components collectively operative to play music, the components including:
i) a memory chip operative to store music;
ii) an integrated circuit in communication with the memory chip and operative to play music stored on the memory chip;
iii) at least one switch in communication with the integrated circuit operative to control operations of the integrated circuit and the memory;
b) a button including:
a flexible member having a rim portion and a hole;
a rigid member sized and configured to be received into the hole;
c) a casing encapsulating the electronic components, the casing having a button aperture with a rim groove about an inner periphery of the button aperture, the button aperture being sized and configured to receive the button and the rim groove being sized and configured to receive the rim portion for providing a water resistant casing such that the electronic components remain dry when the music player is submersed in water.
